(19) United States
(12) Patent Application Publication
(10) Pub. No.: US 2010/0126186 A1
(43) Pub. Date: May 27, 2010

(54) METHOD AND APPARATUS FOR GENERATING A GASEOUS HYDROCARBON STREAM FROM A LIQUEFIED HYDROCARBON STREAM

(75) Inventors: Bruce Michael Marriott, Kuala Lumpur (MY); Chun Kit Poh, The Hague (NL)

Correspondence Address: SHELL OIL COMPANY, P O BOX 2463, HOUSTON, TX, 772522463, US

(73) Assignee: SHELL INTERNATIONALE RESEARCH MAATSCHAPPIJ B.V., The Hague (NL)

(21) Appl. No.: 12/438,958

(22) PCT Filed: Aug. 27, 2007
(86) PCT No.: PCT/EP2007/058863

§ 371 Date: Jan. 19, 2010

(30) Foreign Application Priority Data
Aug. 29, 2006 (EP) 06119678.8

(51) Int. Cl. F17C 9/02

(52) U.S. Cl. 62/50.2; 62/50.5; 62/50.3

(57) ABSTRACT

The present invention relates to a method for generating gaseous hydrocarbon stream from a liquefied hydrocarbon stream (10) such as liquefied natural gas, the method at least comprising the steps of: a) feeding a liquefied hydrocarbon stream (10) at an inlet (21) of a storage tank (2) to provide a liquefied hydrocarbon in the storage tank (2); b) removing at least a part (40) from the liquefied hydrocarbon from the storage tank (2) to provide a removed liquefied hydrocarbon stream (40); c) passing at least a part of the removed liquefied hydrocarbon stream (40) to a line (10, 20) downstream of an expander (4) and upstream of the inlet (21) of the storage tank (2); d) generating and removing a gaseous hydrocarbon stream (50, 60) as fuel gas. The method according to the present invention is particularly suitable for starting up a liquefaction plant.

The present invention relates to a method for generating a gaseous hydrocarbon stream from a liquefied hydrocarbon stream such as liquefied natural gas (LNG).

It is desirable to liquefy a hydrocarbon stream such as natural gas for a number of reasons. As an example, natural gas can be stored in storage tanks and transported over long distances more readily as a liquid than in gaseous form, because it occupies a smaller volume and does not need to be stored at high pressures. Once the LNG (or other liquefied hydrocarbon stream) has reached its destination it is typically off-loaded into other storage tanks from which the LNG can then be revaporized as needed and transported as a gas to end users through pipelines or the like.

U.S. Pat. No. 5,615,561 discloses a method and system for liquefying natural gas. FIG. 5c discloses that some LNG can be withdrawn from a storage tank. This is said to be recycled to the feedstock for the liquefaction process.

EP 1 132 698 A1 discloses a process for the reliquefaction of boiled off vapour from a LNG storage tank. The boiled off vapour is compressed, condensed and returned to the storage tank.

U.S. Pat. No. 3,857,245 discloses a method for reliquefying a part of the gas boiled off from a LNG tank. A LNG stream is withdrawn from the tank.

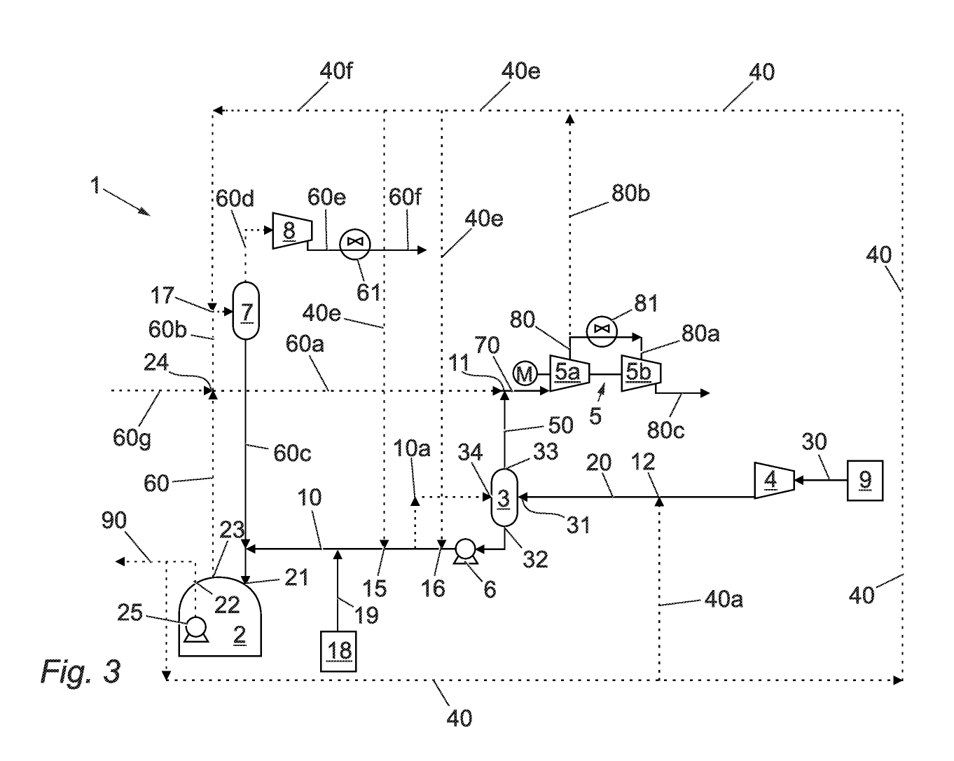

U.S. Pat. No. 3,581,511 discloses a gas liquefaction system. FIG. 3 discloses an embodiment in which subcooled liquid methane is removed from a storage tank. This is combined with a cold gas stream and excess gas from the storage tank to form a mixed refrigerant stream.

FR 1 419 550 discloses a liquefaction process and apparatus, useful for the liquefaction of natural gas. A liquefied gas stream is withdrawn from the LNG storage tank and used to cool the feed stream.

It is known to use gaseous natural gas generated in the liquefaction plant during the liquefaction of the natural gas as a fuel for the liquefaction plant. Also, it is known to use the boil-off gas generated from the LNG in an LNG storage tank as a fuel.

As an example, U.S. Pat. No. 6,658,892 discloses a process for liquefying natural gas, wherein a common separator (i.e. flash vessel) and vapour compressor are used by multiple trains within the system to recover vapour both for cooling and for use as a fuel gas within the liquefaction plant. U.S. Pat. No. 6,658,892 further discloses that, apart from the vapour generated in the flash vessel, also the vapour generated in the storage tank in which the produced LNG is stored is used as a fuel gas.

The amount of fuel generated during the known methods for generating fuel gas from LNG is usually sufficient to operate the liquefaction plant under normal operation conditions.

A problem of the known methods is however that the amount of generated fuel is not sufficient if special circumstances occur.

The above problem is even more pertinent in case a liquefaction plant has to be started up. The starting-up of a liquefaction plant may take a considerable amount of time as the various elements need to be purged and cooled down to the desired operating temperatures, requiring a large amount of fuel. Also, the available fuel gas may not be on-spec.

It is an object of the invention to minimize one or more of the above problems.

It is a further object of the present invention to provide an alternative method for generating a gaseous hydrocarbon stream from a liquefied hydrocarbon stream that can be used as a fuel, in particular during the starting up of a plant for the liquefaction of a hydrocarbon stream, in particular natural gas.

The present invention provides a method for generating a gaseous hydrocarbon stream from a liquefied hydrocarbon stream, the method at least comprising the steps of:

a) feeding a liquefied hydrocarbon stream at an inlet of a storage tank to provide a liquefied hydrocarbon in the storage tank;

b) removing at least a part of the liquefied hydrocarbon from the storage tank to provide a removed liquefied hydrocarbon stream;

c) passing at least a part of the removed liquefied hydrocarbon stream to a line downstream of an expander and upstream of the inlet of the storage tank;

d) generating and removing a gaseous hydrocarbon stream as fuel gas.

In a further aspect the present invention provides an apparatus, the apparatus at least comprising:

a storage tank having an inlet for feeding a liquefied hydrocarbon stream, a first outlet for discharging a liquefied hydrocarbon stream, and a second outlet for discharging a gaseous hydrocarbon stream, said second outlet connected to a fuel gas stream,

the first outlet of the storage tank being connected to a first inlet of a line, the line having a second inlet connected to a point downstream of an expander and the line having an outlet connected to a point upstream of the inlet for the storage tank.

Hereinafter the invention will be further illustrated by the following non-limiting drawings. Herein shows:

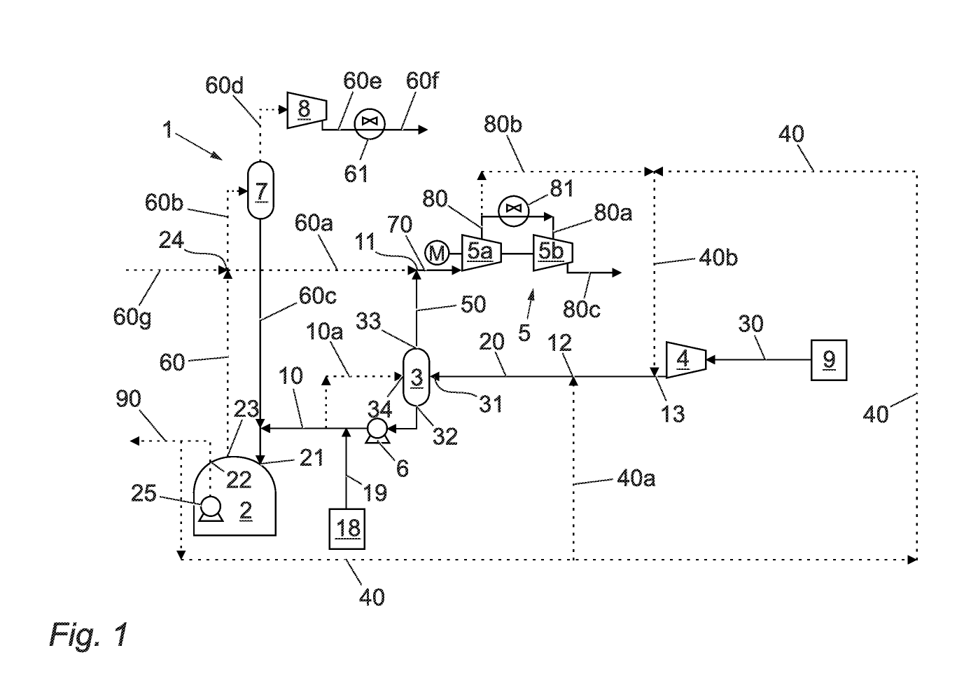

FIG. 1 schematically a process scheme in accordance with an embodiment of the present invention;

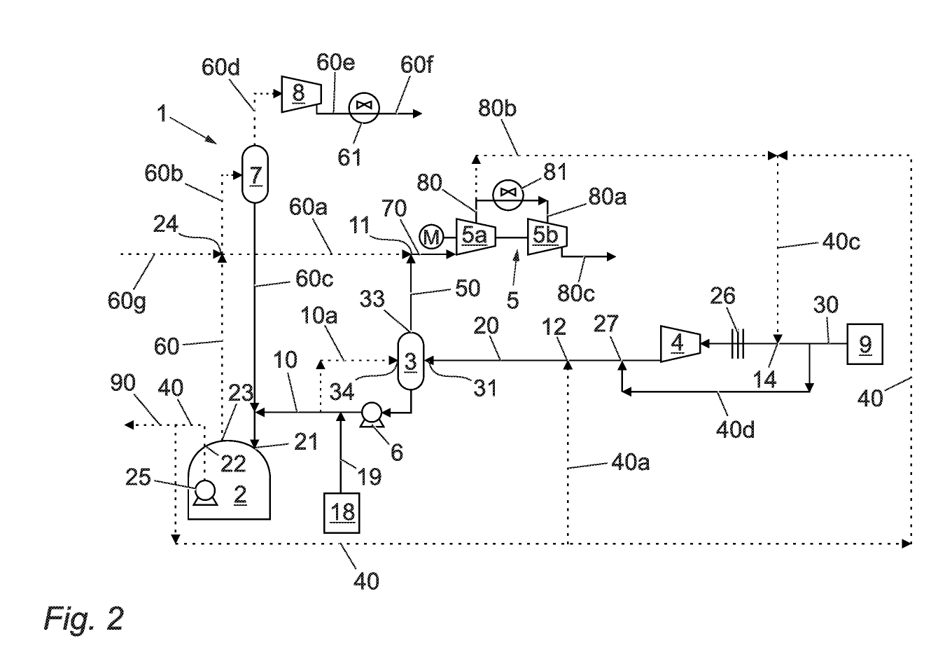

FIG. 2 schematically a process scheme in accordance with another embodiment of the present invention; and

FIG. 3 schematically a process scheme in accordance with a further embodiment of the present invention.

For the purpose of this description, a single reference number will be assigned to a line as well as a stream carried in that line. Same reference numbers refer to similar components.

In various embodiments of the method described herein, a gaseous hydrocarbon stream is generated from a liquefied hydrocarbon stream that may comprise liquefied natural gas. The liquefied hydrocarbon stream may for instance be a removed liquefied hydrocarbon stream obtained by removing at least a part of liquefied hydrocarbon previously fed—as part of a step a)—into a storage tank. The gaseous hydrocarbon stream is generated for use as fuel gas. Generating and removing the gaseous hydrocarbon stream as fuel gas may hereinafter be referred to as step d).

By using such embodiments of the method and/or an embodiment of the apparatus described herein, a surprisingly large amount of fuel gas may be obtained in a very economic manner.

The methods and/or apparatus as described herein may be used during the starting up of a liquefaction plant, such as a LNG plant. In that case, the generated fuel usually will have a more desired composition than the fuel gas that is generated or available during the starting up of the liquefaction plant. In this case the liquefied hydrocarbon stream fed in step a) is then preferably obtained from a separate source, i.e. the liquefied hydrocarbon stream is produced in a different liquefaction plant. An already existing liquefied hydrocarbon stream may be used that has not been liquefied in the plant being started up but that has previously been liquefied in a different liquefaction plant. The liquefied hydrocarbon stream that has been liquefied in a different liquefaction plant may have been produced in a nearby liquefaction train that has already been started up. However, usually the liquefied hydrocarbon stream that has been liquefied in a different liquefaction plant will have been produced in a remote location and shipped or otherwise transported to the location where the plant to be started up is located. The liquefied hydrocarbon stream that has been liquefied in a different liquefaction plant may have been obtained from an offloading LNG carrier vessel or may be temporarily stored in a storage tank.

After the plant has been started up, normal operation can take place and the separate source of liquefied hydrocarbon may be disconnected, as the plant will be in a position to generate its own fuel gas, if necessary.

The fuel gas may be used e.g. to commission fuel gas systems, for power generation of any gas turbines in the plant, to commission electrical distribution systems, to fire heaters, etc.

Preferably the fuel gas is used for firing a gas turbine of the plant, in particular for driving a compressor, preferably a compressor forming part of a refrigeration cycle used for cooling at least part of the hydrocarbon feed stream to be liquefied in the plant to be started up.

An even further advantage of the methods and apparatuses described herein is that equipment and piping systems being situated at the more downstream side of the plant may be started up at an earlier moment, for instance well before the finalisation of the start up of the upstream elements of the liquefaction plant and even before any hydrocarbon feed stream to be liquefied is present.

Furthermore, at least a part of the liquefied hydrocarbon stream may be heat exchanged against a stream used in the plant to be started up. This heat exchange will vaporize the liquefied hydrocarbon to generate a gaseous hydrocarbon stream.

As used herein, the term “starting up” includes the restarting up of an already existing plant as well as the starting up of a new plant. Furthermore, the term “starting up” is not limited to activities performed for cooling down the plant, but also includes the commissioning of a plant, including the activities performed after equipment of the plant has been installed but before the plant is cooled down or before a hydrocarbon feed stream is introduced for actual production of a liquefied hydrocarbon product and fuel gases. The commissioning may e.g. include testing, purging and drying out the various equipment and piping systems.

A further advantage of the methods described herein, when used for starting up a liquefaction plant, is that the loss of time is significantly reduced.

In this respect reference is made to the presentation “Passing the Baton Cleanly” by F. W. Richardson, P. Hunter, T. Diocee and J. Fisher, at GasTech 2000, 12-17 Nov. 2000. This presentation discusses the commissioning, start-up and operation of the Atlantic LNG facilities located at Point Fortin in Trinidad. As can be learned form the above presentation, the starting up of an LNG plant takes a considerable amount of time; it may easily take more than 6 months. In the described process of starting up of the liquefaction plant fuel gas generated during the starting up is used for firing a gas turbine for driving one or more compressors in the refrigerant cycles. A disadvantage of the known method is that the fuel gas available during the starting up may not be on-spec for the gas turbine. Furthermore, the gas turbine is only started up after some fuel gas becomes available to the plant, resulting in a significant loss of time. As according to the present invention on-spec fuel is generated and available before the liquefaction plant is started up, this loss of time is significantly reduced.

The liquefied hydrocarbon feed stream may be any suitable hydrocarbon containing liquefied gas stream, but is usually a liquefied natural gas (LNG) stream, the natural gas having been obtained from natural gas or petroleum reservoirs. As an alternative the natural gas may also have been obtained from another source, also including a synthetic source such as a Fischer-Tropsch process.

Usually the natural gas stream is comprised substantially of methane. Depending on the source, the natural gas may contain varying amounts of hydrocarbons heavier than methane such as ethane, propane, butanes and pentanes as well as some aromatic hydrocarbons. The natural gas stream may also contain non-hydrocarbons such as H₂O, N₂, CO₂, H₂S and other sulphur compounds, and the like.

In another embodiment, the liquefied hydrocarbon stream fed in step a) is obtained from a first outlet of a gas/liquid separator, which gas/liquid separator is fed at a first inlet by a partly condensed hydrocarbon stream. The gas/liquid separator will usually be a flash vessel forming part of a liquefaction plant. The liquefaction plant may be one of various line-ups, without being limited to a specific line-up. As the person skilled readily understands how to liquefy a hydrocarbon stream, this is not further discussed here in full detail. The plant may e.g. comprise one or more heat exchangers with respective refrigerant cycles to cool the feed stream in one or more steps; one or more pre-treating units for removing undesired components from the feed stream such as H₂O, N₂, CO₂, H₂S and other sulphur compounds; a so-called NGL (natural gas liquids) extraction unit to remove one or more hydrocarbons heavier than methane such as ethane, propane, butanes and pentanes; one or more storage tanks for the storage of liquefied product; etc.

The gas/liquid separator is preceded by an expander, wherein the partly condensed hydrocarbon stream is obtained from the expander.

The gaseous hydrocarbon stream generated in step d) of the method may have been generated in several places. Preferably at least a part of the gaseous hydrocarbon stream is removed from a second outlet of the gas/liquid separator. Additionally or alternatively, at least a part of the gaseous hydrocarbon stream is generated in and removed from the storage tank.

According to another embodiment of the present invention, at least a part of the gaseous hydrocarbon stream removed from the storage tank is combined with at least a part of the gaseous hydrocarbon stream removed from the second outlet of the gas/liquid separator.

Usually, the gaseous hydrocarbon stream is compressed thereby obtaining a compressed gaseous hydrocarbon stream.

In what may hereinafter be referred to as step c), at least a part of the removed liquefied hydrocarbon stream (removed from the storage tank) is passed to a line downstream of the expander and upstream of the inlet of the of the storage tank through which the liquefied hydrocarbon stream was fed into the storage tank. Said passing may be done to one or more of several places upstream of the inlet of the storage tank and downstream of the inlet of the expander. In this respect it is noted that according to the present invention “upstream of the inlet of the storage tank” refers to the flows during normal operation of a liquefaction plant of which the storage tank may form a part. Thus, during normal operation a hydrocarbon-containing stream to be liquefied is cooled in one or more heat exchangers thereby obtaining a liquefied hydrocarbon-containing stream that is passed—after optional end flash and other processing steps—to the storage tank.

According to another embodiment at least a part of the removed liquefied hydrocarbon stream is passed to a point between the first outlet of the gas/liquid separator and the inlet of the storage tank, preferably between the first outlet of the gas/liquid separator and a pump.

According to another embodiment at least a part of the removed liquefied hydrocarbon stream is passed to a point between the expander and the first inlet of the gas/liquid separator.

Further at least a part of the removed liquefied hydrocarbon stream may be combined with at least a part of the compressed gaseous hydrocarbon stream thereby obtaining a combined stream, wherein the combined stream is passed to downstream of the expander.

Also it is advantageous when at least a part of the combined stream is passed to a point between the expander and the first inlet of the gas/liquid separator.

Further, at least a part of the combined stream may be passed to a point between the first outlet of the gas/liquid separator and the inlet of the storage tank, preferably between the pump and the inlet of the storage tank.

FIG. 1 schematically shows a process scheme and apparatus (generally indicated with reference No. 1) used for the generation a gaseous natural gas stream from a liquefied hydrocarbon stream 10, which may often be in the form of a natural gas (LNG) stream. This may be desired in case no or not enough on-spec fuel gas is available, in particular during the starting up of an LNG plant.

The apparatus 1 generally comprises an LNG storage tank 2, a gas/liquid separator such as a flash vessel 3 (or any other separator) being upstream of the tank 2, an expander 4 being upstream of the flash vessel 3 and downstream of a LNG source e.g. in the form of liquefaction unit 9, a compressor train 5, a suction drum 7, and a boil-off gas compressor 8.

During use of the apparatus 1 the LNG stream 10 is fed into a storage tank 2 at an inlet 21. Inlet 21 is preferably positioned at the top of the tank 2 or in any other suitable place. The LNG stream 10 may be obtained from various sources. The person skilled in the art will understand that the apparatus 1 may comprise more than one storage tank 2.

As shown in the (non-limiting) embodiment of FIG. 1, the stream 10 is obtained from a first outlet 32 of the flash vessel 3 using rundown pump 6. In the embodiment shown, the outlet 32 is provided at the bottom of flash vessel 3. The flash vessel has been previously fed (at first inlet 31) by partially condensed stream 20 coming from an expander 4. The expander 4 will usually form part of a liquefaction unit 9 in which previously a natural gas stream (not shown) has been liquefied thereby obtaining LNG stream 30. The person skilled in the art will understand that the liquefaction unit 9 may be one of various line-ups, without being limited to a specific line-up. As the person skilled readily understands how to liquefy a hydrocarbon stream such as natural gas, this is not further discussed here.

In an alternative embodiment, e.g. if the liquefaction unit 9 is still to be started up, LNG stream 30 may have been obtained from a separate source, for example from an auxiliary storage tank 18 or from a separate LNG plant that is already running (not shown). The LNG stream from the separate source may instead be supplied directly downstream of the expander 4, for example to line 10 (i.e. as stream 19), for example from auxiliary storage tank 18, to the storage tank 2 of the apparatus 1 instead of (as stream 30) to the expander 4.

After having fed the LNG stream 10 into the storage tank 2, at least a part of the LNG stream fed into the storage tank 2 may be removed at first outlet 22 using pump 25 and passed as a removed liquefied hydrocarbon stream 40 to a point upstream of the inlet 21 of the storage tank 21. As a result, a gaseous natural gas stream is generated in the apparatus 1 and removed for further use as a fuel gas.

If desired a further LNG stream 90 may be removed from the tank 2 (also at first outlet 22 or at a different outlet), which stream 90 may be sent to e.g. a loading facility (not shown) for subsequent shipping. However, the latter will usually only be the case if the LNG unit 9 is fully running.

The gaseous natural gas stream may be generated at one or more places. Preferably, at least a part of the gaseous hydrocarbon stream is generated in the flash vessel 3 and removed at second outlet 33 as stream 50.

Alternatively or additionally, at least a part of the gaseous hydrocarbon stream is generated in the storage tank 2 and removed at second outlet 23 as stream 60.

Furthermore, a part of the gaseous hydrocarbon stream may be generated by heat exchanging the liquefied hydrocarbon stream removed from the storage tank against another stream in the plant to vaporise the liquid hydrocarbon (not shown).

According to another embodiment, at least a part of the gaseous stream 60 removed from the storage tank 2 is combined in a junction point 11 (usually a T-piece or the like) with at least a part of the gaseous stream 50 removed from the second outlet 33 of the flash vessel 3. According to the embodiment of FIG. 1, the gaseous stream 60 is to this end split (at splitter 24) into stream 60a and stream 60b. Optionally, a further gaseous hydrocarbon stream 60g may be added at splitter 24, for instance a gaseous hydrocarbon stream removed from another, separate liquefied hydrocarbon storage tank (not shown).

The stream 60b is sent to a suction drum 7, separating stream 60b into streams 60c and 60d, of which stream 60d is compressed in the boil-off compressor 8. The compressed stream 60e is cooled, for instance in ambient cooler 61, and sent out as fuel stream 60f. Liquid bottom stream 60c from the suction drum 7 may be returned to storage tank 2, optionally after combining with LNG stream 10.

Stream 60a is sent to junction point 11, combined with stream 50 and passed as stream 70 to the compressor train 5. To this end, the junction point 11 has an outlet connected to the compressor train 5, a first inlet connected to the second outlet 33 of the flash vessel 3 and a second inlet connected to the second outlet 23 of the storage tank 2 (via lines 60, 60a).

Subsequently, the gaseous stream 70 (or if no combining takes place in the junction point 11, the gaseous stream 50) is compressed in compressor train 5 thereby obtaining a compressed gaseous stream 80. In the embodiment of FIG. 1, the compressor train 5 comprises two compressors 5a and 5b driven by motor M; if desired, the compressor train 5 may comprise one or more than two compressors instead. After compressing in compressor 5a, the stream 80 may be split into streams 80a and 80b. Stream 80a is cooled, for instance using ambient cooler 81, and subsequently further compressed in compressor 5b and sent out as a fuel stream 80c.

As indicated above, LNG stream 40 from the storage tank 2 is passed to a point upstream of the inlet 21 of the storage tank 2, and downstream of expander 4. In FIG. 1 two of several possible points are indicated to which the stream 40 can be passed. It goes without saying that one or two or more of the indicated or other options may be selected.

At least a part of the LNG stream 40 may be passed (as stream 40a) downstream of the expander 4, preferably between the expander 4 and the first inlet 31 of the flash vessel 3, i.e. at junction point 12. If desired, stream 40a may also be fed as a separate stream to the flash vessel 3.

According to an embodiment at least a part of the LNG stream 40 is combined with at least a part (i.e. stream 80b) of the compressed stream 80 thereby obtaining a combined stream 40b. The combined stream 40b may then be passed to somewhere downstream of the expander 4, e.g. at a junction point 13 having an outlet connected (via line 20) to the first inlet 31 of the flash vessel 3, a first inlet connected to the expander 4 and a second inlet connected to both the first outlet 22 of the storage tank 2 (via lines 40b, 40) and an outlet of the compressor 5a (via lines 40b, 80b, 80).

As further shown in FIG. 1 a part of the stream 10 (i.e. stream 10a) may be sent to a second inlet 34 of the flash vessel 3.

Using methods and/or apparatuses provided by the present invention, a large amount of on-spec fuel gas may be generated in a surprisingly simple and effective manner.

FIG. 2 schematically shows that stream 40 can be combined with stream 80b, the combined stream being subsequently passed (as stream 40c) to a point upstream of the expander 4. In an embodiment of the invention, stream 40c is provided in combination with a stream passed downstream of expander 4, for instance stream 40a. In case no LNG is to be expanded in expander 4, the blind 26 ensures that the expander 4 is bypassed and the stream 40c is then passed as stream 40d to junction point 27 downstream of the expander 4.

FIG. 3 schematically shows a further embodiment according the present invention, wherein it is shown that the combined stream 70 (after compressing in compressor 5a and combining with at least a part of stream 40) is passed as stream 40e to a point (e.g. junction point 15 or 16) between the first outlet 32 of the flash vessel 3 and the inlet 21 of the storage tank 2, preferably between the rundown pump 6 and the inlet 21 of the storage tank 2.

As is clear from FIG. 3, junction point 15 or 16 may have an outlet connected to the inlet 21 of the storage tank 2, a first inlet connected to both the first outlet 22 of the storage tank 2 (via lines 40e, 40) and an outlet of the compressor 5a (via lines 40e, 80b, 80) and a second inlet connected (via pump 6) to the first outlet 32 of the flash vessel 3.

FIG. 3 further shows that stream 40e may be passed (as stream 40f) to suction drum 7, optionally after combining with stream 60b in junction point 17 (e.g. just upstream of the suction drum 7).

The person skilled in the art will readily understand that many modifications may be made without departing from the scope of the invention. As an example, the expander 4 may comprise two or more expansion stages. Further, the junction points 11-17 and 27 may be any device for combining the respective streams into one stream. Also the liquefied hydrocarbon stream 10 may have been fed in the storage tank 2 via outlet 22 (but then temporarily functioning as an inlet) instead of via inlet 21.

1. Method for generating a gaseous hydrocarbon stream from a liquefied hydrocarbon stream, the method at least comprising the steps of:
a) feeding a liquefied hydrocarbon stream into a storage tank via an inlet of the storage tank, to provide a liquefied hydrocarbon in the storage tank;
b) removing at least a part of the liquefied hydrocarbon from the storage tank to provide a removed liquefied hydrocarbon stream;
c) passing at least a part of the removed liquefied hydrocarbon stream to a line downstream of an expander and upstream of the inlet of the storage tank;
d) generating and removing a gaseous hydrocarbon stream as fuel gas.

2. Method according to claim 1, wherein the method is a method of generating a gaseous hydrocarbon stream during starting up of a liquefied natural gas plant.

3. Method according to claim 1, wherein the liquefied hydrocarbon stream fed in step a) is obtained from a first outlet of a gas/liquid separator, which gas/liquid separator is fed at a first inlet by a partly condensed hydrocarbon stream.

4. Method according to claim 3, wherein the partly condensed hydrocarbon stream is obtained from the expander.

5. Method according to claim 3, wherein at least a part of the gaseous hydrocarbon stream is removed from a second outlet of the gas/liquid separator.

6. Method according to claim 1, wherein at least a part of the gaseous hydrocarbon stream is generated in and removed from the storage tank.

7. Method according to claim 5, wherein at least a part of the gaseous hydrocarbon stream is generated in and removed from the storage tank and is combined with the at least part of the gaseous hydrocarbon stream removed from the second outlet of the gas/liquid separator.

8. Method according to claim 1, wherein at least a part of the gaseous hydrocarbon stream is compressed thereby obtaining a compressed gaseous hydrocarbon stream.

9. Method according to claim 3, wherein in step c) at least a part of the removed liquefied hydrocarbon stream is passed to said line at a point between the first outlet of the gas/liquid separator and the inlet of the storage tank.

10. Method according to claim 3, wherein in step c) at least a part of the removed liquefied hydrocarbon stream is passed to the line at a point between the expander and the first inlet of the gas/liquid separator.

11. Method according to claim 8, wherein at least a part of the removed liquefied hydrocarbon stream is combined with at least a part of a compressed gaseous hydrocarbon stream obtained by compressing the gaseous hydrocarbon stream, thereby obtaining a combined stream, wherein the combined stream is passed to downstream of the expander.

12. Method according to claim 11, wherein at least a part of the combined stream is passed to said line at a point between the expander and the first inlet of the gas/liquid separator.

13. Method according to claim 11, wherein at least a part of the combined stream is passed to said line at a point between the first outlet of the gas/liquid separator and the inlet of the storage tank.

14. Method according to claim 11, wherein at least a part of the combined stream is passed to a point downstream of an outlet of the gaseous hydrocarbon stream of the storage tank.

15. Method according to claim 1, wherein at least a part of the liquefied hydrocarbon stream fed in step a) is obtained from a separate source.

16. Method according to claim 15, wherein the separate source comprises an auxiliary storage tank.

17. Method according to claim 1, wherein in step c) at least a part of the removed liquefied hydrocarbon stream is passed to upstream of the expander.

18. Method according to claim 8, wherein at least a part of the removed liquefied hydrocarbon stream is combined with at least a part of the compressed gaseous hydrocarbon stream, thereby obtaining a combined stream, wherein the combined stream is passed to a point upstream of the expander.

19. Apparatus for generating a gaseous hydrocarbon stream from a liquefied hydrocarbon stream, the apparatus at least comprising:
a storage tank having an inlet for feeding a liquefied hydrocarbon stream, a first outlet for discharging a liquefied hydrocarbon stream, and a second outlet for discharging a removed gaseous hydrocarbon stream, said second outlet being connected to a fuel gas stream,
the first outlet of storage tank being connected to a first inlet of a line, the line having a second inlet connected to a point downstream of an expander and the line having an outlet connected to a point upstream of the inlet for the storage tank.

20. Apparatus according to claim 19, further comprising a gas/liquid separator having a first inlet for a partly condensed hydrocarbon stream, a first outlet for a liquefied hydrocarbon stream and a second outlet for a gaseous hydrocarbon stream, wherein the first outlet of the gas/liquid separator is connected to the inlet of the storage tank.

21. Apparatus according to claim 20, wherein the expander is connected to the first inlet of the gas/liquid separator.

22. Apparatus according to claim 21, further comprising a junction point having an outlet connected to the first inlet of the gas/liquid separator, a first inlet connected to the expander and a second inlet connected to the first outlet of the storage tank.

23. Apparatus according to claim 20, further comprising a compressor being connected to the second outlet of the gas/liquid separator.

24. Apparatus according to claim 23, further comprising a junction point having an outlet connected to the compressor, a first inlet connected to the second outlet of the gas/liquid separator and a second inlet connected to the second outlet of the storage tank.

25. Apparatus according to claim 23, further comprising a junction point having an outlet connected to the first inlet of the gas/liquid separator, a first inlet connected to the expander and a second inlet connected to both the first outlet of the storage tank and an outlet of the compressor.

26. Apparatus according to claim 23, further comprising a junction point having an outlet connected to the inlet of the storage tank, a first inlet connected to both an outlet of the storage tank and an outlet of the compressor, and a second inlet connected to the first outlet of the gas/liquid separator.

27. Apparatus according to claim 23, further comprising a junction point having an outlet connected to the expander, a first inlet connected to both the first outlet of the storage tank and an outlet of the compressor, and a second inlet connected to a liquefaction unit.
